(19) United States
(12) Patent Application Publication
(10) Pub. No.: US 2018/0242612 A1
(43) Pub. Date: Aug. 30, 2018

(54) ICE CREAM TRAY MOLD

(71) Applicant: MARCO ANTONIO PEREIRA DA SILVA, AVENTURA, FL (US)

(72) Inventor: MARCO ANTONIO PEREIRA DA SILVA, AVENTURA, FL (US)

(21) Appl. No.: 15/441,305

(22) Filed: Feb. 24, 2017

(51) Int. Cl. A23G 9/08; A23G 9/48; A23G 9/22

(52) U.S. Cl. CPC A23G 9/083; A23G 9/22; A23G 9/48

(57) ABSTRACT

An ice cream maker is provided for making filled flavored frozen confection and whose production follows specific steps, presenting for that purpose a simplified formal structure of easy fitting and handling, allowing the simultaneous production of a plurality of filled flavored frozen confection, specially designed for residential and family use, said ice cream maker being produced of thermoplastic material or other material of similar characteristics, presenting a laminar structure constituted essentially by three elements, namely at least one container, one mold internally and centrally positioned, supported at the surrounding end of the container, which creates a hollow area in the center of the flavored frozen confection mass, and finally a closing.

### FIELD OF TECHNOLOGY

The following refers to an innovative ice cream maker, as well as to the process of making filled ice creams through the ice cream maker, which was especially developed for the manufacture of filled flavored frozen confection. For that purpose, a simplified formal structure of easy fitting and handling, and allowing the simultaneous production of a plurality of filled flavored frozen confection.

Said ice cream maker was specially designed for residential and family use, belonging to the field of home appliances, particularly of the devices for making ice creams and flavored frozen confection.

### BACKGROUND

As widely known by professionals of the home appliance industry and especially by the consumer public, the market offers a plurality of ice cream makers, usually manufactured of thermoplastic material, developed for the making of flavored frozen confection or ice cream mass.

In general, these devices feature a simple formal structure and present several drawbacks, providing bases equipped with container areas to contain the mass of ice cream already prepared in liquid or pasty form, getting a cap with a handle at one end and a stick at the other, the latter one designed to be embraced by the already frozen block of ice cream mass.

Such existing devices are easily found in the consumer market and have no commercial appeal and not even a playful sale appeal, in addition to the difficulty that arises at the time of unmolding the product for consumption.

Knowing these drawbacks and interested in providing improvements to the houseware market, particularly to the thermoplastic ice cream makers, the inventor of this application, active in the market and always concerned in offering new high quality products which facilitate the handling by the consumer user, created and developed an ice cream maker with a modern design and innovative functional features for the occasion, allowing the removal of one ice cream at a time, keeping the remaining products intact.

### SUMMARY

An aspect relates to an ice cream maker that is capable of producing ice creams with fillings, and not just an ice cream maker that receives an homogeneous and single amount of mass to produce flavored frozen confection or a mass of ice cream on a stick.

Thus, the applicant has developed this “ICE CREAM MAKER FOR MAKING FILLED FLAVORED FROZEN CONFECTION”, which should provide even more benefits to the consumer market, positioning itself with full prominence among its congeners and customizing itself at the consumer market by the fact of presenting an ice cream maker made of thermoplastic material or other material with similar characteristics, constituted basically of a rectangular base or other suitable shape, provided with holes in which the main containers containing the external flavored frozen confection mass will be embedded, and within each main container a mold is positioned which can be removed when the outer mass is frozen thereby creating an area for the insertion of the ice cream filling, and then the cap of the main container will be positioned, in which transversal center is provided, on one side the stick that will be embraced by the filling inserted in the hole produced in the first step of the ice cream freezing, and on the other side said stick extends to form the handle.

The main advantage of said ice cream maker is, therefore, to offer the consumer public the possibility to produce a new and differentiated flavored frozen confection, which can be filled, allowing several combinations of flavors, and still endowed with a strong commercial appeal because it produces ice creams of the Mexican palette type.

Another objective of said ice cream maker is to promote the possibility of making several units of ice creams, because there are, in the main containers of the ice creams, engagement means between each unit, said engagement means providing a mooring between the units, forming a plurality of units fixed to each other, vertically and securely positioned for the insertion of the ice cream in a cooling and/or freezing unit.

### BRIEF DESCRIPTION

Some of the embodiments will be described in detail, with reference to the following figures, wherein like designations denote like members, wherein:

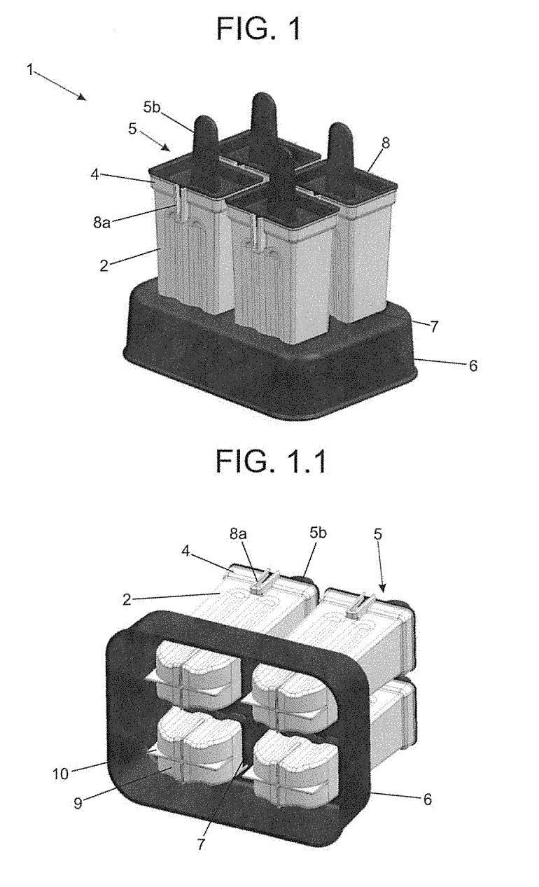

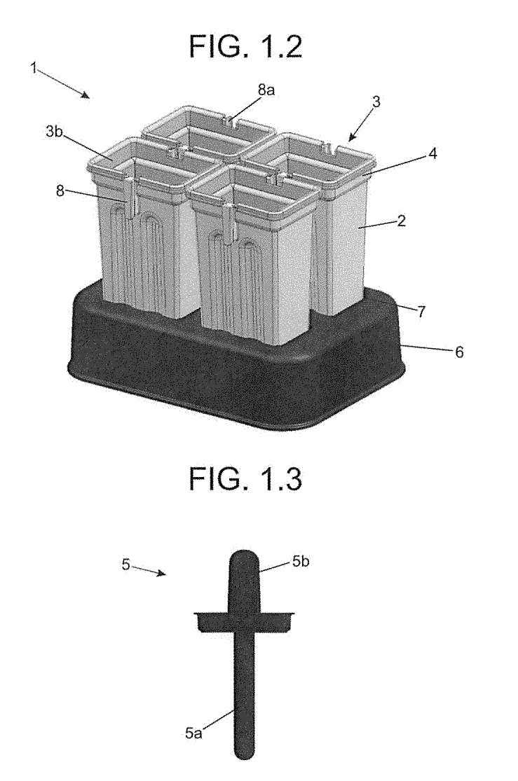

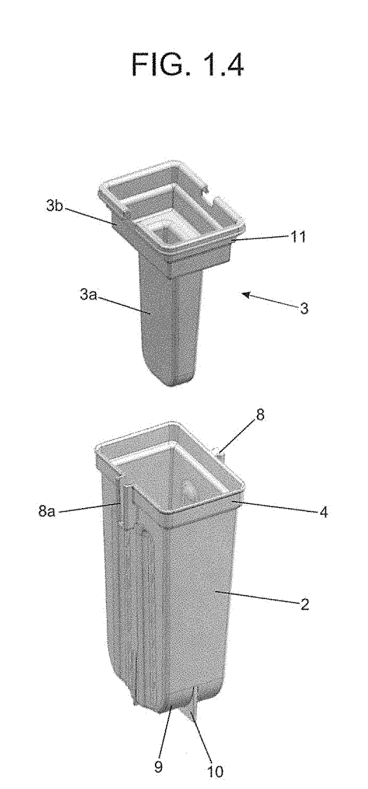

FIG. 1 shows a front perspective view of the ice cream maker;

FIG. 1.1 shows a lower perspective view of the ice cream maker;

FIG. 1.2 shows a rear perspective view of the assembly without the caps of the main container;

FIG. 1.3 shows a front view of the cap;

FIG. 1.4 shows a perspective view of the mold and the main container;

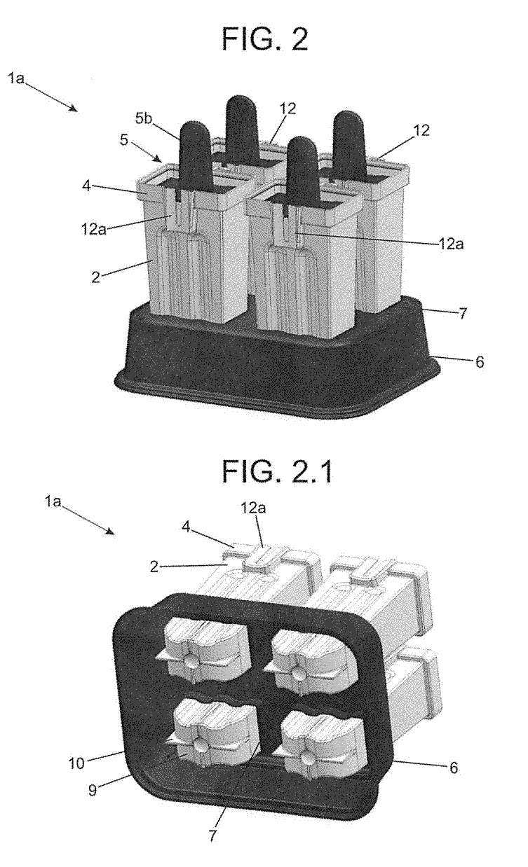

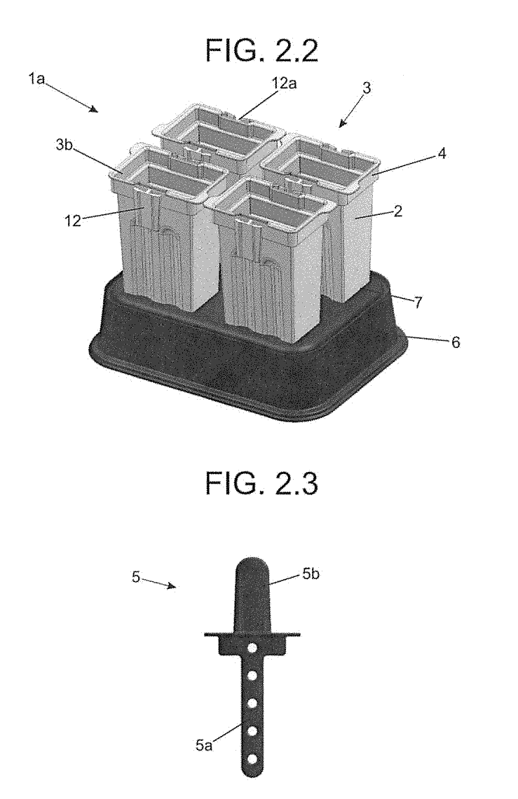

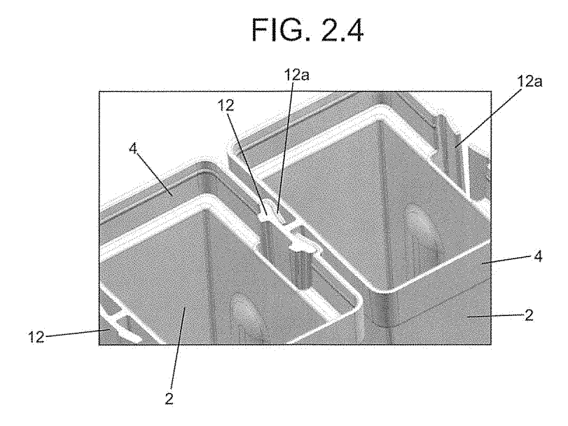

FIG. 2 shows an alternative construction, in a front perspective view of the ice cream maker;

FIG. 2.1 shows an alternative construction, in a lower perspective view of the ice cream maker;

FIG. 2.2 shows an alternative construction, in a rear perspective view, of the assembly without the caps of the main container;

FIG. 2.3 shows an alternative construction in a front view of the cap and;

FIG. 2.4 shows a detailed view of an alternative construction of the ice cream maker.

### DETAILED DESCRIPTION

According to the illustrations of the above mentioned figures, the following produced of thermoplastic material or other material with similar characteristics, comprises a laminar structure of basically four elements, namely at least one container (2) for containing the flavored frozen confection mass, one mold (3) internally and centrally positioned, supported at the surrounding end (4) of the container (2), which creates a hollow area in the center of the flavored frozen confection mass, and finally a closing cap (5) comprising a transverse rod relative to said cap (5) and longitudinal relative to the container (2), said rod passing transversally through its cap (5), wherein an internal portion (5a) is inserted into the hollow area created by the internal mold (3) to aggregate the mass of the filling, and the other one, the external portion (5b), conforms the handle.

In addition to these elements, the ice cream maker set (1) is likely to provide also a means for the containment and positioning of the containers (2) for the insertion of same into a freezing unit, defined by a laminar base (6) provided with holes (7) on its upper face, corresponding to the engagements at the ends of the containers (2).

Alternatively, said laminar base (6) replaces the holes (7) corresponding to the ends of the containers, by recesses corresponding to the containers (2) containing the outer mass of the flavored frozen confection.

An alternative means for the containment and positioning of the containers, said means foreseen on the ice cream maker set (1) now being claimed by the applicant, is represented by the presence of engagement means for the interconnection of two or more containers (2), that is, said devices being disposed diametrically opposed and specially designed for the interconnection of one or more container (2) units, allowing it to be more easily brought into a freezing unit, wherein one side face comprises the “male” portion (8) of said device and the other side face comprises the corresponding “female” portion (8a), for the engagement of two or more containers (2) in order to arrange them vertically before they are placed into a freezing unit.

The container (2) also provides an alternative constructive variation related to the interconnection system shown in FIG. 2.1, in which the “male” portion (12) comprises a format in which their side locks are extended relative to the “male” portion (8), and the “female” portion (12a) comprises a wider internal gap with respect to the “female” portion (8a) with the purpose of providing a better conformation to the “male” portion (12) and for providing greater stability to the united containers, as illustrated in FIG. 2.4.

The container (2) comprises the shape of a Mexican palette, that is, with a slightly reversed pyramidal trunk format, being elongated and provided with a free extreme portion of semicircular shape (9).

The container (2) of the ice cream maker (1a) also presents an alternative constructive variation, in which the free extreme portion of semicircular shape (9) contains a gap in its central portion of semispherical shape.

Each of the containers (2) of the ice cream maker (1) comprises, at its free end, a surrounding salience (4) forming a step or cradle for supporting and positioning the free end of the internal mold (3), said mold (3) being divided into two distinct portions, namely, a laminar body (3a) with a format similar to the main container (2) although of smaller dimension, and an upper portion (3b) of rectangular shape, provided with a surrounding band (11) capable of fitting in the also surrounding salience (4) carried out at the free end of the container body (2).

The internal mold (3) also presents an alternative constructive variation, where in its upper portion (3b) there are two tabs with a slightly longer length than the main container (2), which has the purpose to facilitate the withdrawal of the same without the need of greater efforts or defrosting of the mass, as illustrated in FIG. 2.2.

After being inserted into a freezing unit and the first portion of the flavored frozen confection is frozen, that is, the outer portion of the ice cream, the mold (3) can be removed and the liquid or pasty filling can be introduced into the central hole produced in the ice cream, and later on the cap (5) of the flavored frozen confection can be positioned, which holds the inner rod (5a) and which will be incorporated into the filling, and the rod (5b) of the handle, which is external, can again be taken back to a freezing unit for the finishing of the product.

Said cap (5) of the flavored frozen confection also comprises an alternative constructive variation, in which the internal rod (5a) presents five equidistant central holes, which provide increased stability to the flavored frozen confection, as the mass will also freeze through said internal rod (5a) and not only around it, as can be observed in FIG. 2.3.

As a further alternative construction, the container (2) of the ice cream maker set (1) comprises two diametrically opposed laminar extensions (10) carried out on its circular border, that help to maintain the verticality of each container (2).

The process of using said ice cream maker set (1) comprises the following steps:
i. Filling the container (2) with the ice cream mass;
ii. Installation of the mold (3) over the container (2) filled with the ice cream mass;
iii. Cooling the container (2) filled with the ice cream mass and assembled with the mold (3) until its respective mass is frozen;
iv. Withdrawal of the mold (3);
v. Completing the frozen mass in the container (2) with the desired filling;
vi. Sealing of the filling with an increase of ice cream mass;
vii. Mounting the cap (5) over the container (2);
viii. Cooling the container (2) containing the frozen mass, the desired filling and the ice cream mass for sealing, assembled with the cap (5).

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. An ice cream maker for making filled flavored frozen confection, comprising an ice cream maker produced of thermoplastic material or other material with similar characteristics, comprising a laminar structure of basically three elements, namely at least one container, one mold internally and centrally positioned, supported at the surrounding end of the container, which creates of a hollow area in the center of the flavored frozen confection mass, and finally a closing cap comprising a transverse rod relative to said cap and longitudinal relative to the container, said rod passing transversally through its cap, wherein an internal portion is inserted into the hollow area created by the internal mold, and the other one, the external portion, conforms the handle.

2. The ice cream maker according to claim 1, wherein said ice cream maker set provides a device for the containment and positioning of the containers, defined by a laminar base provided with holes on its upper face, corresponding to the engagements at the ends of the containers.

3. The ice cream maker according to claim 1, and to an alternative construction, wherein the laminar base presents recesses corresponding to the containers containing the external flavored frozen confection mass.

4. The ice cream maker according to claim 1, wherein said ice cream maker presents, in each container, an engagement device between two or more containers, that is, said devices being arranged diametrically opposed to each other, and a side face which comprises the “male” portion of said device and the other side face which comprises the correspondent “female” portion.

5. The ice cream maker according to claim 1 and to an alternative construction, wherein the “male” portion comprises locks of extended length and the “female” portion comprises a wider gap.

6. The ice cream maker according to claim 1, wherein said container has the shape of a Mexican palette, that is, with a slightly reversed pyramidal trunk format, being elongated and provided with a free extreme portion of semicircular shape.

7. The ice cream maker according to claim 1, and to an alternative construction, wherein said container comprises, at its free extreme portion of semicircular shape, a gap of semispherical shape.

8. The ice cream maker according to claim 1, wherein each of the containers of the ice cream maker comprises, at its free end, a surrounding salience forming a step or cradle for supporting and positioning the free end of the internal mold, said mold being divided into two distinct portions, namely, a laminar body with a format similar to the main container although of smaller dimension, and an upper portion of rectangular shape, provided with a surrounding band capable of fitting in the also surrounding salience carried out at the free end of the container body.

9. The ice cream maker according to claim 1, and to an alternative construction, wherein said internal mold comprises two lateral tabs with a slightly longer length than the main container.

10. The ice cream maker according to claim 1, and to an alternative construction, wherein said rod of said cap comprises five equidistant central holes.

11. The ice cream maker according to claim 1, wherein the mass of the flavored frozen confection is inserted into said container and subsequently the mold is inserted, which can be removed after the outer mass of the flavored frozen confection freezes, subsequently the filling is added into the hollow mass area, and then the cap is inserted which holds the internal rod that incorporates the filling, and the external rod of the handle for the finishing of the product.

12. The ice cream maker according to claim 1, wherein the container of the ice cream maker set comprises two diametrically opposed laminar extensions carried out at its circular end.

13. A process of making filled ice creams through an ice cream maker, comprising the following steps:
i. filling the container with the ice cream mass;
ii. installation of the mold over the container filled with the ice cream mass;
iii. cooling the container filled with the ice cream mass and assembled with the mold until its respective mass is frozen;
iv. withdrawal of the mold;
v. completing the frozen mass in the container with the desired filling;
vi. sealing of the filling with an increase of ice cream mass;
vii. mounting the cap over the container; and
viii. cooling the container containing the frozen mass, the desired filling and the ice cream mass for sealing, assembled with the cap.
